(19) United States
(12) Patent Application Publication
(10) Pub. No.: US 2007/0177932 A1
(43) Pub. Date: Aug. 2, 2007

(54) Record of incident

(76) Inventors: Sharon Ott, Apache Junction, AZ (US); Elizabeth E. Martinez, Apache Junction, AZ (US)

Correspondence Address: JAMES RAY & ASSOCIATES, 2640 PITCAIRN ROAD, MONROEVILLE, PA, 15146, US

(21) Appl. No.: 11/655,500

(22) Filed: Jan. 19, 2007

Related U.S. Application Data
(60) Provisional application No. 60/762,691, filed on Jan. 27, 2006.

(51) Int. Cl. B42F 13/40

(52) U.S. Cl. 402/3

(57) ABSTRACT

An apparatus for compiling all vital and pertinent information necessary in regard to an accident. The apparatus comprises a foldable binder member having each of a predetermined shape and a predetermined size and formed of a predetermined material. There is at least one worksheet having predetermined information printed thereon and disposed within the foldable binder member for recording all such vital information that is needed regarding such accident. A closure member is disposed on the binder member for keeping the binder member securely closed and protected, a portion of the closure member is disposed on a base portion of the binder member and a second portion of the closure member is disposed on a top portion of the foldable binder member.

### CROSS REFERENCE TO RELATED APPLICATIONS

This application is closely related to and claims benefit from U.S. Provisional Application Ser. No. 60/762,691 filed Jan. 27, 2006.

### FIELD OF THE INVENTION

The present invention relates, in general, to a note taking guide, and, more particularly, the present invention relates to note taking guide designed to facilitate the process of collecting information concerning an automobile accident.

### BACKGROUND OF THE INVENTION

Automobile accidents occur daily, whether it is merely a fender bender, a rear end collision or a hit and run accident that occurs in a parking lot or a serious accident on the highway. When a motor vehicle accident occurs, it is easy to become confused and forget to acquire the necessary information. Most drivers are completely unprepared in the event of their involvement in an accident and are at a loss as to what information is needed and are unprepared to collect all of the necessary and pertinent information concerning the accident. Glove compartments are often full of junk rather than having a notepad and pen necessary for taking notes and the personal information of those involved in such accident.

For those who have never been involved in an accident, it can be a very frightening experience and it is extremely difficult for the person involved in the accident to know what specific information will be needed by either the police of the insurance company.

Thus, it would be advantageous if there were a means available that would provide the driver involved in an accident with tips and/or forms needed to compile a complete and accurate explanation of the incident and a list of information needed to collect from an insurance company or for other purposes.

### SUMMARY OF THE INVENTION

In a first aspect the present invention provides an apparatus for compiling all vital and pertinent information necessary in regard to an accident. The apparatus comprises a foldable binder member having each of a predetermined shape and a predetermined size and formed of a predetermined material. There is at least one worksheet having predetermined information printed thereon and disposed within the foldable binder member for recording all such vital information that is needed regarding such accident. A closure means is disposed on the binder member for keeping the binder member securely closed and protected, a portion of the closure means is disposed on a base portion of the binder member and a second portion of the closure member is disposed on a top portion of the foldable binder member.

### OBJECTS OF THE INVENTION

It is, therefore, one of the primary objects of the present invention is to provide a means for recording a complete and accurate explanation of an accident.

Another object of the present invention is to provide a list of information needed in reporting such accident to an insurance company.

Still another object of the present invention is to provide a means for collecting such information that is located in one place.

Yet another object of the present invention is to provide a means for collecting such information that can be kept in a glove compartment.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the binder of the apparatus of the present invention in a closed position showing one closure means.

FIG. 2 is a perspective view of the binder shown in FIG. 1 showing a different closure means.

FIG. 3 is a perspective view of the binder member shown in FIGS. 1 and 2 with the binder in an open position showing one means of securing such information sheet in a secure position for entering the pertinent information.

FIG. 4 is a perspective view of the binder member shown in FIGS. 1 and 2 with the binder in an open position showing a different means for securing the such information sheet in a secure position for entering the pertinent information.

FIG. 5 is a plan view of one of the accident recording pages disposed in the binder shown in FIGS. 1 and 2 with preprinted information needed for an accident report.

FIG. 6 is a plan view of a sketch sheet in the binder shown in FIGS. 1 and 2 for describing the accident.

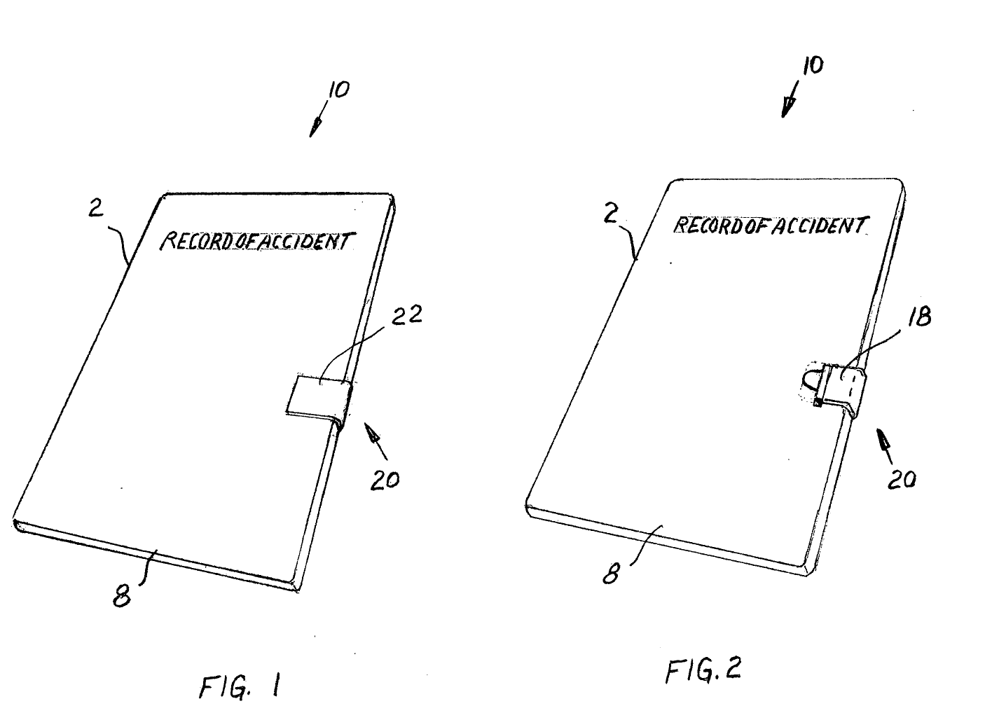

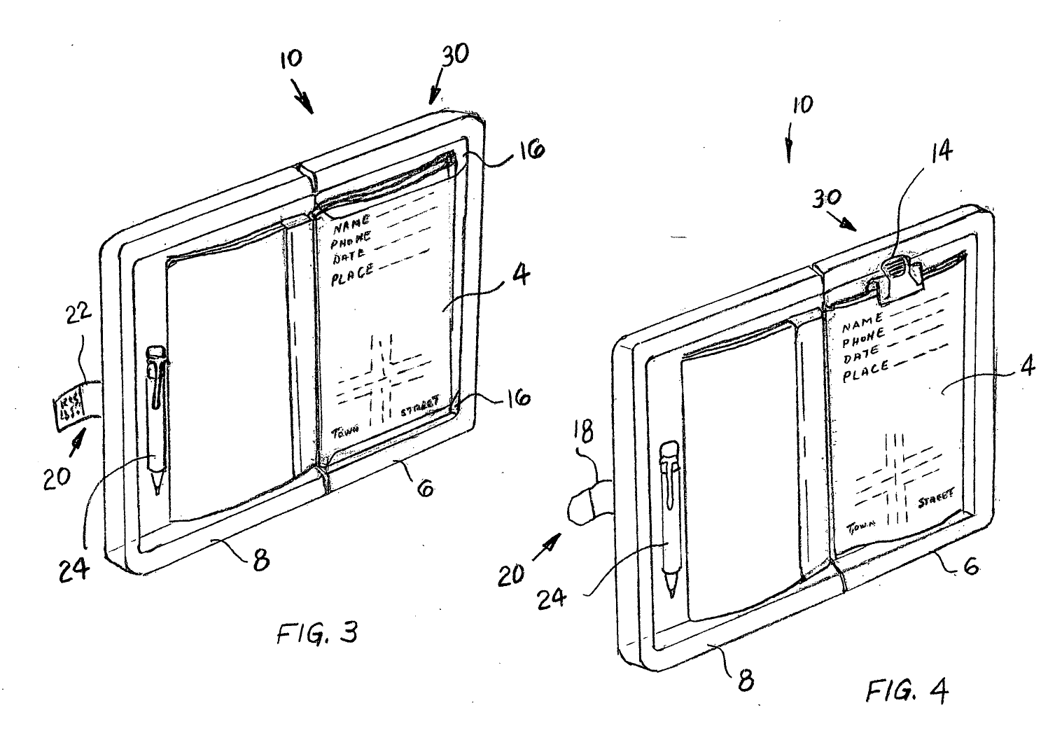

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

When an accident occurs it is important to know what to do and what information is important to obtain. If injuries occur then obviously the first item would be to call the police or 911 to tell them medical assistance is needed to care for the injured parties. Even without injuries it is always a good idea to report the accident to the police because many insurance companies will not cover an accident unless there is police accident report. However, some police departments will not come to every accident scene because of the non severity of the accident or the location (e.g. Some police authorities will not come to the scene if the accident is on private property such as shopping center unless there are injuries.) One should also be aware that most policies require notification of police within a specified period if the accident is a hit and run.

Further, it is extremely important that the person involved in an accident obtain all the necessary information at the scene of the accident. Thus, the present invention provides an apparatus, generally designated 10, for compiling all vital and pertinent information necessary in regard to an accident. The apparatus 10 comprises a foldable binder member 2 having each of a predetermined shape and a predetermined size and formed of a predetermined material. There is at least one worksheet 4 having predetermined information printed thereon and disposed within the foldable binder member 2 for recording all such vital information that is needed regarding such accident. A closure means, generally designated 20, is disposed on such foldable binder member 2 for keeping such binder member 2 securely closed and protected, a portion of the closure means 20 is disposed on a base portion 6 of the binder member 2 and a second portion of the closure means 20 is disposed on a top portion 8 of the foldable binder member 2.

The at least one worksheet 4 further includes a sketch sheet 12 shown in FIG. 6 for describing such accident. The sketch sheet 12 provides a layout of an intersection and a parking lot for assisting the user in describing the accident. Some of the information provided on such worksheet 4 further includes a section for providing a complete description of any damages that were incurred by either or both cars that were involved in the accident. It is presently preferred that there be a plurality of such worksheets 4 disposed in the binder member 2.

It is also presently preferred that such binder member 2 is substantially rectangular and also that such predetermined size of such binder member 2 is a size that is small enough to fit into a standard glove compartment of an automobile.

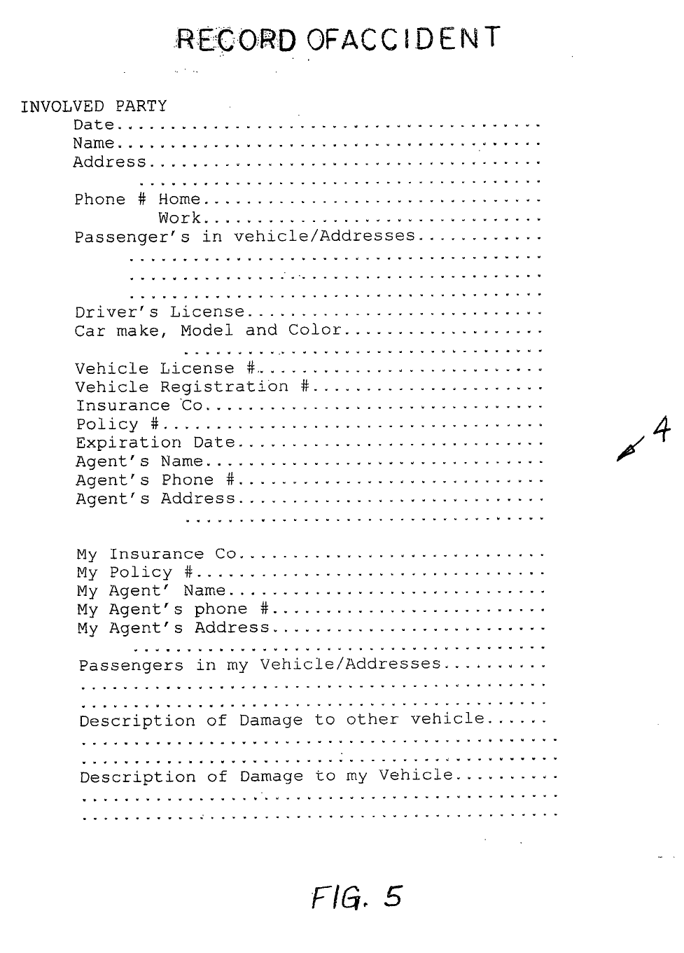

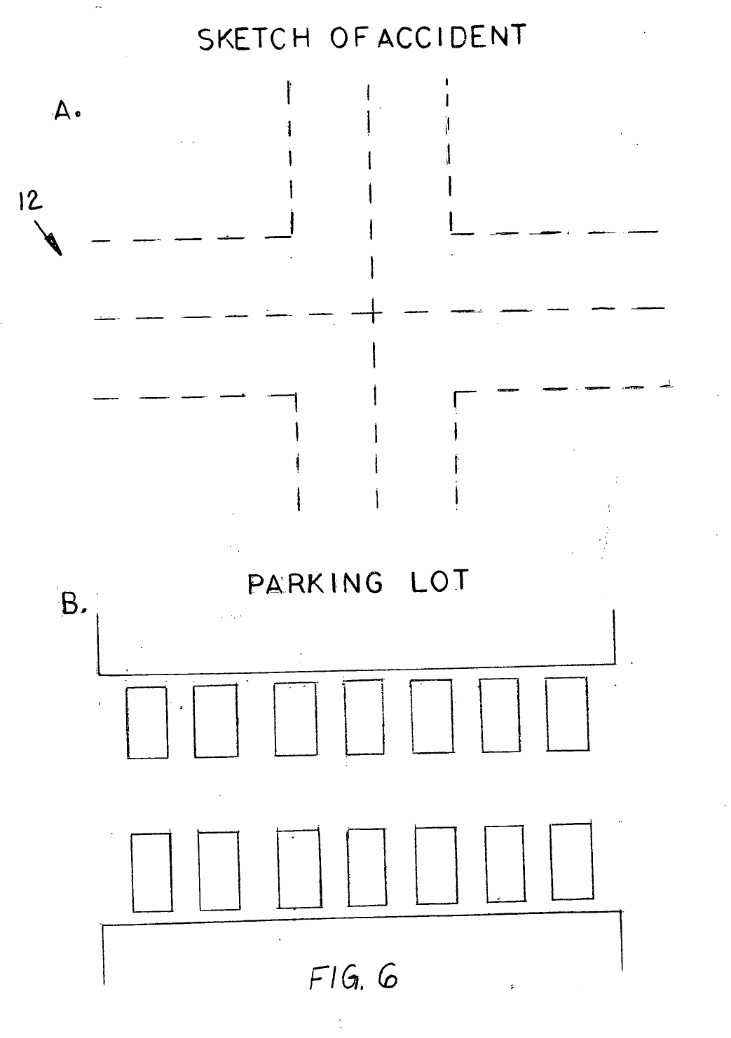

There is also a second means, generally designated 30, for holding and securing such at least one worksheet 4 in a writing position. Such second means includes one of a clip 14, snap and a strip 16. As seen in FIG. 5 such strip 16 is a clear plastic strip 16 disposed at the top and bottom of the binder member 2 wherein the worksheet 4 is slid between these strips 16 and thereby held in place. As is seen in FIG. 6 such clip 14 is spring loaded and secures the worksheet(s) 4 in place for writing on the worksheet 4.

Such predetermined material for the foldable binder member is selected from one of vinyl and leather and such closure means 20 is one of a snap latch 18 and hook and loop material 22.

It is preferred that such hook and loop material 22 be used when the binder member is made of vinyl and that such snap latch 18 be used when the binder member 2 is made of leather. It is also preferred that such foldable binder member 2 be reinforced so as to provide a more solid surface on which to write.

Such binder member 2 further includes a writing utensil 24 disposed within the foldable binder member 2. Such writing utensil 24 is one of a pen or a pencil. It is preferred that such writing utensil is a ball point pen.

Thus, the present invention provides a record of incident which contains a preprinted list of all of the necessary information needed to collect answers even if the person is shaken up or dazed. All of the necessary information needed is provided along with a writing implement and all of this is contained in a closable binder and kept in the glove compartment of the automobile. Since it is in the glove compartment it is always handy and available and a person doesn't have to search all over for something to write on and then try to remember what information is necessary for the insurance company—it's all in one place.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. An apparatus for compiling all vital and pertinent information necessary in regard to an accident, said apparatus comprising:
(a) a foldable binder member having each of a predetermined shape and a predetermined size and formed of a predetermined material;
(b) at least one worksheet having predetermined information printed thereon and disposed within said foldable binder member for recording all said vital information that is needed regarding such accident; and
(c) a first means disposed on said binder member for keeping said binder member securely closed and protected, a portion of said first means is disposed on a base portion of said binder member and a second portion of said closure member is disposed on a top portion of said foldable binder member.

2. The apparatus, according to claim 1, wherein said at least one worksheet further includes a sketch sheet for describing such accident.

3. The apparatus, according to claim 1, wherein said predetermined material for said foldable binder member is one of vinyl and leather.

4. The apparatus, according to claim 3, wherein said closure means is one of a snap latch and hook and loop material.

5. The apparatus, according to claim 3, wherein said predetermined material is vinyl.

6. The apparatus, according to claim 5, wherein said first means is hook and loop material.

7. The apparatus, according to claim 1, wherein at least one portion of said foldable binder member is reinforced so as to provide a solid surface on which to write.

8. The apparatus, according to claim 1, wherein said apparatus further includes a writing utensil disposed within said foldable binder member.

9. The apparatus, according to claim 8, wherein said writing utensil is one of a pen and a pencil.

10. The apparatus, according to claim 9, wherein said writing utensil is a ball point pen.

11. The apparatus, according to claim 1, wherein said at least one worksheet further includes a section for providing a complete description of any damages that were incurred.

12. The apparatus, according to claim 1, wherein said at least one worksheet includes a plurality of worksheets.

13. The apparatus, according to claim 1, wherein said predetermined shape of said binder member is substantially rectangular.

14. The apparatus, according to claim 1, wherein said predetermined size is a size small enough to fit into a standard automobile glove compartment.

15. The apparatus, according to claim 1, wherein said foldable binder further includes a second means for holding said at least one worksheet in a writing position.

16. The apparatus, according to claim 15, wherein said second means includes one of a clip, snap and a strip.

17. The apparatus, according to claim 16, wherein said second means is a clip.
